(19) United States
(12) Patent Application Publication
(10) Pub. No.: US 2018/0195562 A1
(43) Pub. Date: Jul. 12, 2018

(54) CENTRIFUGAL CLUTCH ASSEMBLY

(71) Applicant: Eaton Corporation, Cleveland, OH (US)

(72) Inventor: Suraj Gopal, Pune (IN)

(73) Assignee: Eaton Corporation, Cleveland, OH (US)

(21) Appl. No.: 15/914,082

(22) Filed: Mar. 7, 2018

Related U.S. Application Data
(63) Continuation of application No. PCT/US2016/050492, filed on Sep. 7, 2016.
(60) Provisional application No. 62/330,335, filed on May 2, 2016.

(30) Foreign Application Priority Data
Sep. 7, 2015 (IN) 2807/DEL/2015

(51) Int. Cl. F16D 43/18; F16D 13/76; F16C 19/02

(52) U.S. Cl. CPC F16D 43/18; F16H 55/49; F16C 19/02; F16D 13/76

(57) ABSTRACT

A rotor assembly includes a rotor plate, a friction shoe slidably coupled to the rotor plate and configured to move in a radial direction, and a biasing mechanism operably coupled to the friction shoe and configured to force the friction shoe in a radially inward direction. A predetermined rotation of the rotor plate imparts a centrifugal force on the friction shoe sufficient to overcome the biasing force of the biasing mechanism such that the friction shoe moves in a radially outward direction.

### CROSS-REFERENCE TO RELATED APPLICATIONS

This application is a continuation of International Application No. PCT/US2016/050492 filed Sep. 7, 2016, which claims the benefit of Indian Patent Application No. 2807/DEL/2015 filed on Sep. 7, 2015, and U.S. Provisional Application No. 62/330,335 filed on May 2, 2016. The disclosures of the above applications are incorporated herein by reference.

### FIELD

The present disclosure relates generally to clutch assemblies for vehicles, and more particularly, centrifugal clutch assemblies for vehicles.

### BACKGROUND

Centrifugally operated friction clutches are well known in the art of vehicle drive train systems and typically include an input member driven by a prime mover such as an electric motor or internal combustion engine. The clutches may include rotatable weights that, upon rotation of the driving member, move radially outward under the effect of centrifugal force to cause the input member to frictionally engage a driven output member.

Some automatically actuated centrifugal clutches are drivingly connected to an engine flywheel and include centrifugal actuation modules that house the centrifugally actuated weights. Each centrifugally actuated weight is adapted to swing in an arc about a pivot link fixed to the module housing structure. As such, the swing weights contained within the modules are movable in the radially outward direction against resistive spring forces as a function of engine speed. The higher the engine speed, the greater the outward movement. Rollers attached to the weights are adapted to roll atop ramp segments that are cammed for clutch engagement and disengagement.

However, some swing weights may be subjected to a number of forces and thus may give rise to competing concerns to achieve satisfactory operation of the modules over the useful life of a clutch. Accordingly, it is desirable to provide an improved centrifugal clutch assembly.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one aspect, a rotor assembly for a centrifugal clutch assembly is provided. The rotor assembly includes a rotor plate, a friction shoe slidably coupled to the rotor plate and configured to move in a radial direction, and a biasing mechanism operably coupled to the friction shoe and configured to force the friction shoe in a radially inward direction. A predetermined rotation of the rotor plate imparts a centrifugal force on the friction shoe sufficient to overcome the biasing force of the biasing mechanism such that the friction shoe moves in a radially outward direction.

In addition to the foregoing, the described assembly may include one or more of the following features: wherein the biasing mechanism is a radial expander spring; wherein the biasing mechanism is a compression spring; wherein the biasing mechanism is a wave spring; wherein the rotor plate includes a plurality of support walls extending therefrom, the friction shoe disposed between adjacent support walls of the plurality of support walls; wherein at least one support wall of the plurality of support walls includes an inner surface having a guide slot defined therein; wherein the friction shoe includes a flange configured to be received within the guide slot; wherein the friction shoe includes a frame, the biasing mechanism disposed between the frame and a compression tab extending from the rotor plate; and wherein the biasing mechanism is disposed radially inward of the friction shoe.

In another aspect, a centrifugal clutch assembly is provided. The assembly includes a housing having an inner diameter surface and a rotor assembly at least partially disposed within the housing. The rotor assembly includes a rotor plate, a friction shoe slidably coupled to the rotor plate and configured to move in a radial direction, and a biasing mechanism operably coupled to the friction shoe and configured to force the friction shoe in a radially inward direction. A predetermined rotation of the rotor plate imparts a centrifugal force on the friction shoe sufficient to overcome the biasing force of the biasing mechanism such that the friction shoe moves in a radially outward direction into contact with the housing inner diameter surface.

In addition to the foregoing, the described assembly may include one or more of the following features: wherein the biasing mechanism is a radial expander spring; wherein the biasing mechanism is a compression spring; wherein the biasing mechanism is a wave spring; wherein the rotor plate includes a plurality of support walls extending therefrom, the friction shoe disposed between adjacent support walls of the plurality of support walls; wherein at least one support wall of the plurality of support walls includes an inner surface having a guide slot defined therein; wherein the friction shoe includes a flange configured to be received within the guide slot; wherein the friction shoe includes a frame, the biasing mechanism disposed between the frame and a compression tab extending from the rotor plate; wherein the biasing mechanism is disposed radially inward of the friction shoe; a bearing assembly disposed between the housing and the rotor assembly to allow relative movement therebetween; and wherein the bearing assembly includes an outer race coupled to the rotor assembly, an inner race coupled to the housing, and a plurality of ball bearings disposed between the outer race and the inner race.

### BRIEF DESCRIPTION OF THE DRAWINGS

The present disclosure will become more fully understood from the detailed description and the accompanying drawings, wherein:

FIG. 1 is an exploded view of an example centrifugal clutch assembly in accordance with the principles of the present disclosure;

FIG. 2 is a perspective view of a portion of the centrifugal clutch assembly shown in FIG. 1;

FIG. 3 is a perspective view of a portion of the centrifugal clutch shown in FIG. 1;

FIG. 4 is a cross-sectional view of the centrifugal clutch assembly shown in FIG. 1 and taken along line 4-4;

FIG. 5 is a cross-sectional view of the centrifugal clutch assembly shown in FIG. 1 and taken along line 5-5;

FIG. 6 is a cross-sectional view of another example centrifugal clutch assembly in accordance with the principles of the present disclosure;

FIG. 7 is a cross-sectional view of the centrifugal clutch assembly shown in FIG. 6 and taken along line 7-7; and

FIG. 8 is a cross-sectional view of a portion of the assembly shown in FIG. 7 with an example biasing mechanism in accordance with the principles of the present disclosure.

### DETAILED DESCRIPTION

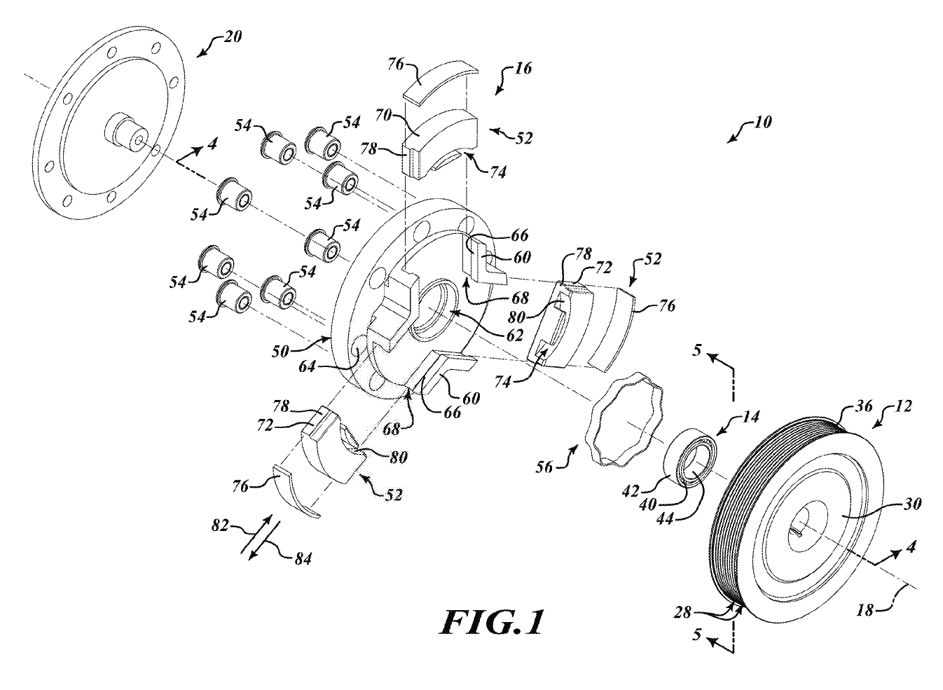

With initial reference to FIG. 1, an example centrifugal clutch assembly 10 is illustrated that generally includes a housing 12, a bearing assembly 14, and a rotor assembly 16 arranged about a longitudinal axis 18. The clutch assembly 10 may be positioned between a vehicle engine and a compressor of a transport refrigeration system such as found on a truck or trailer (not shown).

For example, the vehicle engine may be operably coupled to the rotor assembly 16 through an engine flywheel and dowel pins or belts (not shown). The housing 12 may be operably coupled to the compressor such that torque is transmitted between the engine flywheel (via flywheel adapter 20) and the compressor via the rotor assembly 16. As such, the vehicle engine may be used to run the compressor when the vehicle is traveling. An auxiliary electric motor (not shown) may be operably coupled to the housing 12 and configured to operate the compressor when the vehicle engine is idling or not running.

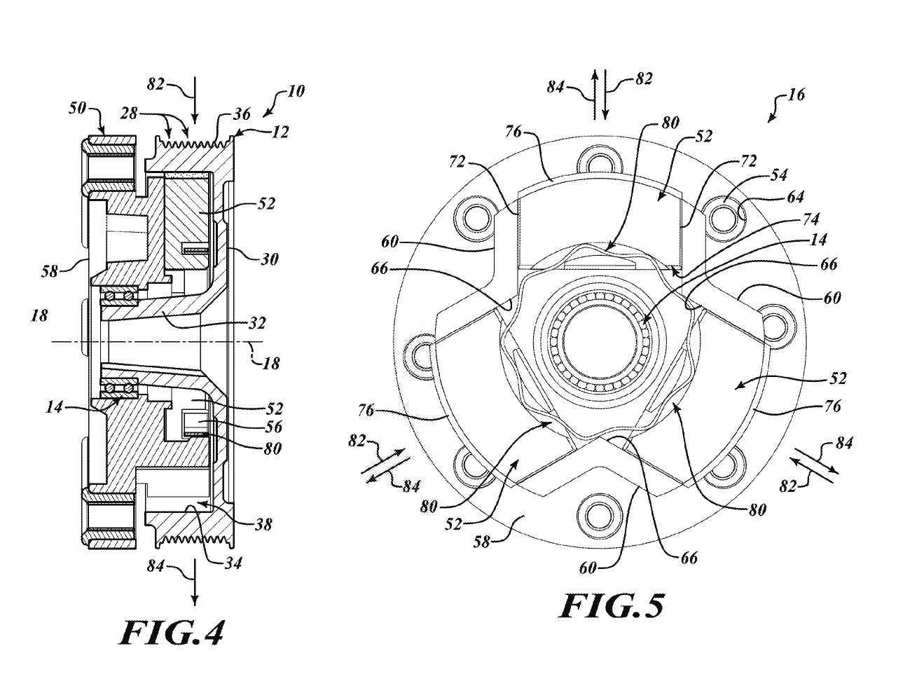

As illustrated in FIG. 4, the housing 12 may be generally cylindrical and include an end wall 30, a tubular stem 32, an inner diameter surface 34, and an outer diameter surface 36. The end wall 30 and the inner diameter surface 34 may define a cavity 38 configured to at least partially receive the rotor assembly 16.

The tubular stem 32 may be configured to receive and couple to a drive shaft of the compressor, and to couple to the rotor assembly 16 via the bearing assembly 14. The inner diameter surface 34 may be configured to be selectively engaged by a portion of the rotor assembly 16, as is described herein in more detail. The outer diameter surface 36 may be configured with one or more circumferential V-grooves 28 configured to receive V-belts (not shown) connected to the auxiliary electric motor. As such, the auxiliary electric motor can continue to operate the compressor, for example, when the vehicle is parked overnight and the engine is not running.

In the illustrated example, the bearing assembly 14 may include a plurality of ball bearings 40 disposed between an outer race 42 and an inner race 44. The outer race 42 may be coupled to the rotor assembly 16, and the inner race 44 may be coupled to the tubular stem 32 of housing 12. As such, the bearing assembly 14 is configured to provide relative movement between the housing 12 and the rotor assembly 16.

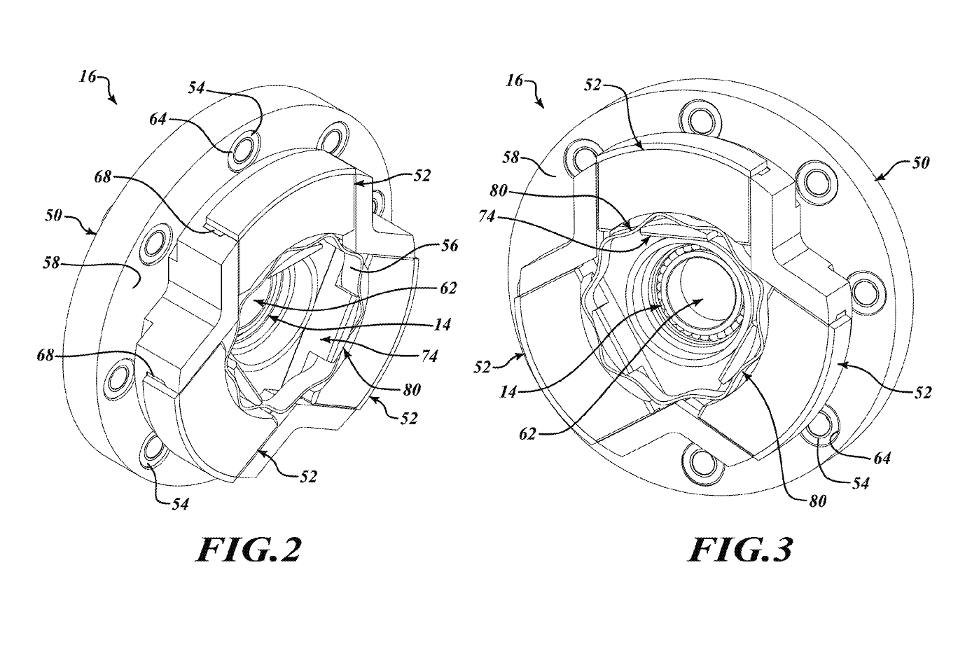

With further reference to FIGS. 2, 3, and 5, in the illustrated example, the rotor assembly 16 may generally include a rotor plate 50, a plurality of friction shoes 52, a plurality of outer bushings 54, and a biasing mechanism 56.

The rotor plate 50 may include a main body portion 58 and friction shoe support walls 60 extending therefrom. The main body portion 58 may include a central aperture 62 and a plurality of bushing apertures 64 formed therein. The central aperture 62 may be configured to receive the bearing assembly 14 and/or the flywheel adapter 20 or other component coupled to the vehicle engine, and the bushing apertures 64 may each be configured to receive one outer bushing 54. The friction shoe support walls 60 each include an inner surface 66 in which a guide slot 68 may be formed that is configured to receive at least a portion of one of the friction shoes 52.

The friction shoes 52 may each include an outer surface 70 (see FIG. 1), side surfaces 72, and an inner surface portion 74. The outer surface 70 is configured to couple to a friction liner 76, and side surfaces 72 are each formed with a flange 78 configured to be disposed in one guide slot 68 of the friction shoe support walls 60. Accordingly, as illustrated in FIGS. 2, 3, and 5, each friction shoe 52 is disposed between two support walls 60, and the flanges 78 are disposed in opposed guide slots 68 such that the friction shoe 52 is configured to slide in a radial direction of the rotor plate 50 and axis 18 (i.e., radially inward and outward). The inner surface portion 74 may include a retaining groove 80 formed therein and configured to retain at least a portion of the biasing mechanism 56.

The outer bushings 54 may be arranged radially about the rotor plate in the bushing apertures 64. The outer bushings 54 may be formed of a pliable, semi-rigid material such as rubber, and may be configured to receive a drive pin from the engine flywheel (not shown) such that the engine flywheel drives the rotor plate 58.

In the example illustrated in FIGS. 1-5, the biasing mechanism 56 is a radial expander spring configured to provide a radial inward force. The radial expander spring 56 may include a generally undulating body and is configured to be disposed within each of the retaining grooves 80 in a generally circular fashion about the rotor plate central aperture 62 and axis 18. As such, the biasing mechanism 56 may provide a radial inward force on each of the friction shoes 52 in the direction of arrows 82.

In an example operation, when the rotor assembly 16 is stationary, the biasing mechanism 56 forces the friction shoes 52 in a radially inward direction 82. The friction shoes 52 are configured to slide along guides slots 68 in a radially outward direction 84 (e.g., opposite arrow 82) upon a predetermined rotation speed of the rotor assembly 16. As such, at the predetermined rotation speed, the centrifugal force imparted on the friction shoes 52 may overcome the radially inward biasing force of the biasing mechanism 56, and the friction shoes 52 may subsequently slide radially outward such that the friction liners 76 contact and engage the housing inner diameter surface 34. As a result, the rotor assembly 16 may be frictionally coupled to the housing 12 to transfer rotary motion therebetween.

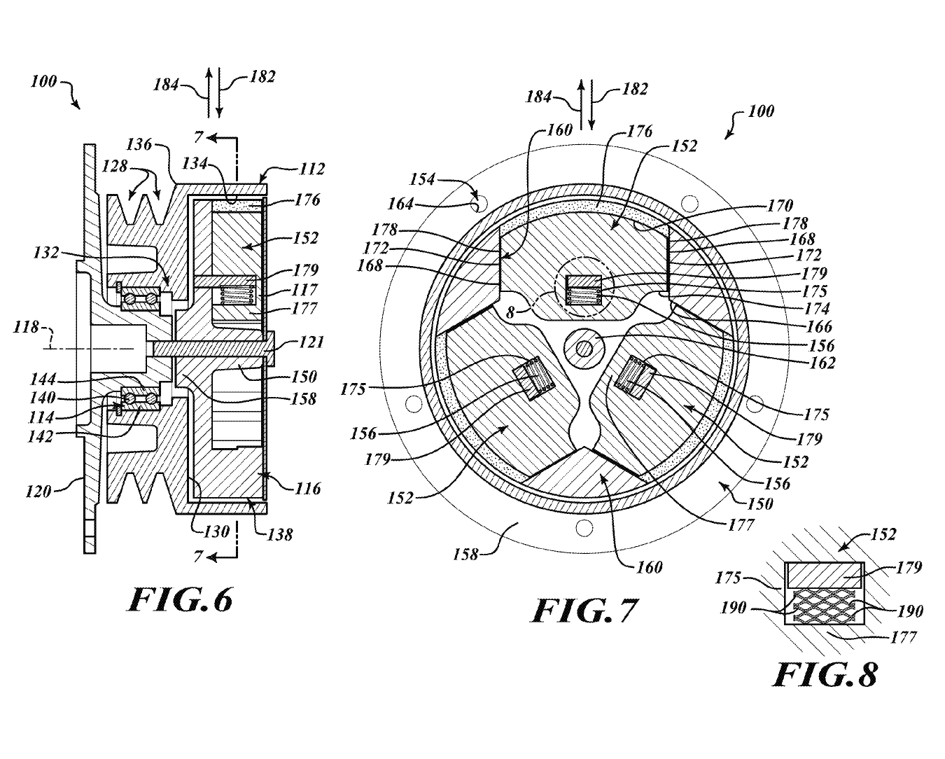

FIGS. 6 and 7 illustrate another example centrifugal clutch assembly 100 that is similar to the centrifugal clutch assembly 10 except that it includes a biasing mechanism 156 and/or 190.

The centrifugal clutch assembly 100 generally includes a housing 112, a bearing assembly 114, and a rotor assembly 116 arranged about a longitudinal axis 118. The clutch assembly 100 may be positioned between a vehicle engine and a compressor of a transport refrigeration system such as found on a truck or trailer (not shown).

For example, the vehicle engine may be operably coupled to the rotor assembly 116 through a flywheel adapter 120, and the housing 112 may be operably coupled to the compressor such that torque is transmitted between the flywheel adapter 120 and the housing 112 via the rotor assembly 116. As such, the vehicle engine may be used to run the compressor when the vehicle is traveling. An auxiliary electric motor (not shown) may be operably coupled to the housing 112 and configured to operate the compressor when the vehicle engine is idling or not running.

In the illustrated example, the housing 112 may be generally cylindrical and include an end wall 130, a tubular stem 132, an inner diameter surface 134, and an outer diameter surface 136. The end wall 130 and the inner diameter surface 134 may define a cavity 138 configured to at least partially receive the rotor assembly 116.

The tubular stem 132 may be configured to receive and couple to a drive shaft of the compressor, and to couple to the rotor assembly 116 via the bearing assembly 114. The inner diameter surface 134 may be configured to be selectively engaged by a portion of the rotor assembly 116, as is described herein in more detail. The outer diameter surface 136 may be configured with one or more circumferential V-grooves 128 configured to receive V-belts (not shown) connected to the auxiliary electric motor. As such, the auxiliary electric motor can continue to operate the compressor, for example, when the vehicle is parked overnight and the engine is not running.

In the illustrated example, the bearing assembly 114 may include a plurality of ball bearings 140 disposed between an outer race 142 and an inner race 144. The outer race 142 may be coupled to the housing 112, and the inner race 144 may be coupled to the flywheel adapter 120, which is coupled to the rotor assembly 116 (via a bolt 121) for rotation therewith. The flywheel adapter 120 may be coupled with the rotor assembly 116 through a plurality of toothed contacts (not shown) formed on a surface of the flywheel adapter 120 and the rotor plate 158 meshing with each other. Belt 121 may also be used to secure the connection therebetween. As such, the bearing assembly 114 is configured to provide relative rotational movement between the housing 112, and the rotor assembly 16 and/or flywheel adapter 120.

The rotor assembly 16 may generally include a rotor plate 150, a plurality of friction shoes 152, a plurality of fasteners 154, and a plurality of biasing mechanisms 156.

The rotor plate 150 may include a rotor hub 158 and friction shoe support walls 160 extending therefrom. The rotor hub 158 may include a central aperture 162 and a plurality of fastener apertures 164 formed therein. The central aperture 162 may be configured to receive the bolt 121, and the fastener apertures 164 may each be configured to receive a fastener 154. The friction shoe support walls 160 each include an inner surface 166 in which a guide slot 168 may be formed configured to receive at least a portion of one of the friction shoes 152.

The friction shoes 152 may each include an outer surface 170, side surfaces 172, an inner surface 174, and a frame 175. The outer surface 170 is configured to couple to a friction liner 176, and side surfaces 172 are each formed with a flange 178 configured to be disposed in one guide slot 168 of the friction shoe support walls 160 (e.g., similar to slots 68 and flanges 78 shown in FIG. 1). Accordingly, as illustrated in FIG. 7, each friction shoe 152 is disposed between two support walls 160, and the flanges 178 are disposed in opposed guide slots 168 such that the friction shoe 152 is configured to slide in a radial direction of the rotor plate 150 and axis 118 (i.e., radially inward and outward). As illustrated in FIG. 6, the frame 175 is coupled to the inner surface 174 and includes an extension 177 disposed proximate a compression tab 179 extending from the rotor plate 150.

The outer fasteners 154 may be arranged radially about the rotor plate in the fastener apertures 164. The fasteners 154 may be formed of a hardened material such as metal.

In the illustrated example, the biasing mechanism 156 is a compression spring configured to provide a radial inward force to the friction shoe 152. The compression spring 156 is disposed between the frame extension 177 and the compression tab 179. As such, the biasing mechanism 156 may provide a radial inward force on each of the friction shoes 152 in the direction of arrows 182. In an alternative example, shown in FIG. 8, the biasing mechanism may be one or more wave springs 190 disposed between the frame extension 177 and the compression tab 179.

In an example operation, when the rotor assembly 116 is stationary, the biasing mechanism 156, 190 forces the friction shoes 152 in a radially inward direction 182. The friction shoes 152 are configured to slide along guides slots 168 in a radially outward direction 184 (e.g., opposite arrow 182) upon a predetermined rotation speed of the rotor assembly 116. As such, at the predetermined rotation speed, the centrifugal force imparted on the friction shoes 152 may overcome the radially inward biasing force of the biasing mechanism 156, 190, and the friction shoes 152 may subsequently slide radially outward such that the friction liners 176 contact and engage housing inner diameter surface 134. As a result, the rotor assembly 116 may be frictionally coupled to the housing 112 to transfer rotary motion therebetween.

A method of assembling centrifugal clutch assembly 10, 100 comprises providing housing 12, 112, bearing assembly 14, 114, and rotor assembly 16, 116. The rotor assembly 16, 116 is formed with a rotor plate 50, 150 having a plurality of support walls 60, 160 extending therefrom, which include a guide slot 68, 168 to receive a flange 78, 178 of one friction shoe 52, 152. The friction shoes 52, 152 are slidingly disposed between adjacent support walls 60, 160, and a biasing mechanism 56, 156, 190 is operably coupled to the friction shoe 52, 152 to provide a radially inward biasing force thereto.

Described herein are systems and methods for centrifugal clutch assemblies that utilize radially inward biasing mechanisms. The assemblies include a rotor assembly with friction shoes coupled to a rotor plate and slidable in a radial direction thereof. A biasing mechanism is operably coupled to the friction shoe to bias the friction shoe in a radially inward direction. A predetermined rotation of the rotor assembly imparts centrifugal force on the friction shoe sufficient to overcome the biasing force of the biasing mechanism, which results in radially outward movement of the friction shoe. This movement may bring friction shoe into contact with a housing, thereby resulting in a transfer of rotary motion between the housing and rotor assembly. Accordingly, the systems and methods provide a centrifugal clutch assembly with reduced parts and improved operation.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A rotor assembly for a centrifugal clutch assembly, the rotor assembly comprising:
a rotor plate;
a friction shoe slidably coupled to the rotor plate and configured to move in a radial direction;
a biasing mechanism operably coupled to the friction shoe and configured to force the friction shoe in a radially inward direction, wherein a predetermined rotation of the rotor plate imparts a centrifugal force on the friction shoe sufficient to overcome the biasing force of the biasing mechanism such that the friction shoe moves in a radially outward direction.

2. The rotor assembly of claim 1, wherein the biasing mechanism is a radial expander spring.

3. The rotor assembly of claim 1, wherein the biasing mechanism is a compression spring.

4. The rotor assembly of claim 1, wherein the biasing mechanism is a wave spring.

5. The rotor assembly of claim 1, wherein the rotor plate includes a plurality of support walls extending therefrom, the friction shoe disposed between adjacent support walls of the plurality of support walls.

6. The rotor assembly of claim 5, wherein at least one support wall of the plurality of support walls includes an inner surface having a guide slot defined therein.

7. The rotor assembly of claim 6, wherein the friction shoe includes a flange configured to be received within the guide slot.

8. The rotor assembly of claim 1, wherein the friction shoe includes a frame, the biasing mechanism disposed between the frame and a compression tab extending from the rotor plate.

9. The rotor assembly of claim 1, wherein the biasing mechanism is disposed radially inward of the friction shoe.

10. A centrifugal clutch assembly comprising:
a housing having an inner diameter surface; and
a rotor assembly at least partially disposed within the housing, the rotor assembly including:
a rotor plate;
a friction shoe slidably coupled to the rotor plate and configured to move in a radial direction;
a biasing mechanism operably coupled to the friction shoe and configured to force the friction shoe in a radially inward direction, wherein a predetermined rotation of the rotor plate imparts a centrifugal force on the friction shoe sufficient to overcome the biasing force of the biasing mechanism such that the friction shoe moves in a radially outward direction into contact with the housing inner diameter surface.

11. The clutch assembly of claim 10, wherein the biasing mechanism is a radial expander spring.

12. The clutch assembly of claim 10, wherein the biasing mechanism is a compression spring.

13. The clutch assembly of claim 10, wherein the biasing mechanism is a wave spring.

14. The clutch assembly of claim 10, wherein the rotor plate includes a plurality of support walls extending therefrom, the friction shoe disposed between adjacent support walls of the plurality of support walls.

15. The clutch assembly of claim 14, wherein at least one support wall of the plurality of support walls includes an inner surface having a guide slot defined therein.

16. The clutch assembly of claim 15, wherein the friction shoe includes a flange configured to be received within the guide slot.

17. The clutch assembly of claim 10, wherein the friction shoe includes a frame, the biasing mechanism disposed between the frame and a compression tab extending from the rotor plate.

18. The clutch assembly of claim 10, wherein the biasing mechanism is disposed radially inward of the friction shoe.

19. The clutch assembly of claim 10, further comprising a bearing assembly disposed between the housing and the rotor assembly to allow relative movement therebetween.

20. The clutch assembly of claim 19, wherein the bearing assembly includes:
an outer race coupled to the rotor assembly;
an inner race coupled to the housing; and
a plurality of ball bearings disposed between the outer race and the inner race.
